(19) United States
(12) Patent Application Publication
(10) Pub. No.: US 2010/0033974 A1
(43) Pub. Date: Feb. 11, 2010

(54) LAMP MODULE FOR PROJECTORS

(76) Inventor: Henning Rehn, Berlin (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/311,444

(22) PCT Filed: Oct. 12, 2007
(86) PCT No.: PCT/EP2007/060866

§ 371 Date: Mar. 30, 2009

(30) Foreign Application Priority Data
Oct. 20, 2006 (DE) 10 2006 049 600.0

(51) Int. Cl. F21V 7/00

(52) U.S. Cl. 362/308; 362/310; 362/235

(57) ABSTRACT

A lamp module is disclosed, in particular for projectors for data or video projection, having at least one lamp (2) which is inserted into a reflector (4) and has a discharge vessel (6) with two lamp shafts (8, 10) arranged diametrically opposite one another. According to the invention, a light-deflecting optical lens (12) is provided in order to deflect the radiation emitted from the lamp from the outlet-side lamp shaft (10).

### TECHNICAL FIELD

The invention relates to a lamp module, in particular for projectors for data or video projection, having at least one lamp that is inserted into a reflector and has a discharge vessel with two lamp shafts arranged diametrically relative to one another.

### PRIOR ART

The market for digital projectors for data or video projection has been growing strongly globally since the invention of DLP technology. This increasing expansion is also based, inter alia, on the fact that the technologies used enable the projectors to be manufactured ever more cost-effectively and to be designed with such compact dimensions that they can be used in mobile fashion in everyday office life. In particular, there is a need for flat data projectors. This also gives rise to restrictions on the design of the illumination optics with reference to reflector diameter and reflector height. In this case, solutions are required that in comparison to conventional designs retain the brightness on the screen as far as possible, that is to say enable the same electric power of the lamp and a similar lighting efficiency of the lamp module for a given useful light. The problem consists in that for a given electric power the lamp cannot become smaller, and it follows that the entire lamp module (lamp and reflector) cannot easily be reduced in size. If only the reflector were to be reduced in size, operation

could become impossible for thermal reasons, and a substantial reduction in efficiency could also occur owing to geometrical reasons.

In the case of digital projection systems, use as light source is predominantly made of reflector high pressure discharge lamps such as are described, for example, at www.osram.de under the designation of video and projection lamps (VIP-Lamps). These reflector high pressure discharge lamps have a high pressure discharge lamp which is inserted into a reflector. When designing such reflector high pressure discharge lamps, care must be taken that neither the reflector nor the lamp are thermally damaged at the very high temperatures occurring. The lamps are provided as a rule with a discharge vessel that is arranged approximately in the middle and merges into two lamp shafts arranged diametrically relative to one another. If an attempt is made to accede to the requisite flat design by means of a small reflector, this would have a small focal length and a small spacing of the focal points, since the numerical eccentricity of the reflector is substantially prescribed by the desired angular distribution; a small spacing of the focal points therefore leads, owing to the thermally conditioned axially length of the lamp, to the fact that a portion of the output radiation is reflected onto the end section of the shaft, thus resulting in an undesired shading—that leads to a vignetting of the reflected light bundle—and to a heavy thermal loading of the lamp shaft.

It is proposed in US 2006/0126341 A1 to design the reflector in such a way that the output radiation does not strike the lamp shaft, and is firstly focused

downstream of the shaft end by means of a body of rotation that is arranged along the optical axis of the lamp and designed as a toric asphere, and is guided into an integrator such that shading and additional heating of the lamp shaft are avoided. However, it has been shown that such a design is efficient only for small focal lengths of the reflector, so that either only low wattage lamps with a small outer bulb diameter can be used or the efficiency is lower. The luminous flux obtainable on the screen is therefore restricted.

### SUMMARY OF THE INVENTION

It is the object of the invention to provide a lamp module that has a minimum installation space and a high optical efficiency.

This object is achieved by a lamp module, in particular for projectors for data or video projection, having at least one lamp that is inserted into a reflector and has a discharge vessel with two lamp shafts arranged diametrically relative to one another, a light directing optical lens being provided for deflecting the radiation, emitted by the lamp, from the exit-side lamp shaft. Particularly advantageous designs of the invention are described in the dependent claims.

In the solution according to the invention, the light directing optical lens deflects the radiation emitted by the lamp from the exit-side lamp shaft such that shading by the lamp shaft is prevented

or substantially reduced, and the maximum efficiency of the lamp module is ensured. Since the light exit surface of the lens offers a further degree of freedom for adapting the emitted light bundle to the desired angular distribution, the numerical eccentricity of the reflector can be selected to be larger than the prior art in accordance with US 2006/0126341 A1, and this enables a longer focal length and therefore use of lamps of high power with corresponding bulb diameters, in conjunction with the same focal point. In the case of one exemplary embodiment of the invention, the reflector is designed as an ellipsoid, at least in some sections, and has a numerical eccentricity in the range of approximately 0.80 to 0.85.

In accordance with a particularly preferred exemplary embodiment of the invention, the lens has a recess that is penetrated at least in some sections by the exit-side lamp shaft of the lamp.

It has proved to be particularly advantageous when the lens has on the reflector side a concave light entry surface, and on the exit side a convex light exit surface. The lens can be designed as a positive lens.

In a preferred design of the invention, the light entry and/or light exit surface is of conical, spherical or aspheric design.

In one variant of the invention, the lens is designed in such a way that the light exit surface is arranged downstream of the end of the exit side lamp shaft.

The connection between reflector and lens can be further optimized when said connection is provided with flats in order to push the lens onto the reflector.

The lens is preferably mounted on the reflector, and can thus form a front panel of the lamp module such that the latter is sealed, at least in some sections.

In the case of discharge lamps for projection systems, the discharge arc is arranged at the focal point of the shorter focal length of the reflector. This focal length preferably lies in the range of approximately 6 to 8 mm—it has been shown that this measure constitutes an optimum compromise between a compact design and a minimal thermal loading of the lamp and of the reflector.

The lamp is preferably designed as a high-pressure discharge lamp, in particular as a mercury high-pressure discharge lamp. In one design of the invention, the lamp shafts of the lamp have a diameter in the range of approximately 4 to 7.5 mm, preferably of 6 mm.

In one design of the invention, the adjustment of the lamp is performed in the preassembled module composed of reflector and lens.

The inventive lamp module can be used, for example, in digital data and video projectors.

### BRIEF DESCRIPTION OF THE DRAWINGS

The invention is explained in more detail below with the aid of preferred exemplary embodiments. In the drawing:

FIG. 1 shows a side view of a lamp module in accordance with a first inventive exemplary embodiment;

FIG. 2 shows a side view of a lamp module in accordance with a second inventive exemplary embodiment; and

FIG. 3 shows a plan view of the lamp module from FIG. 2.

### PREFERRED DESIGN OF THE INVENTION

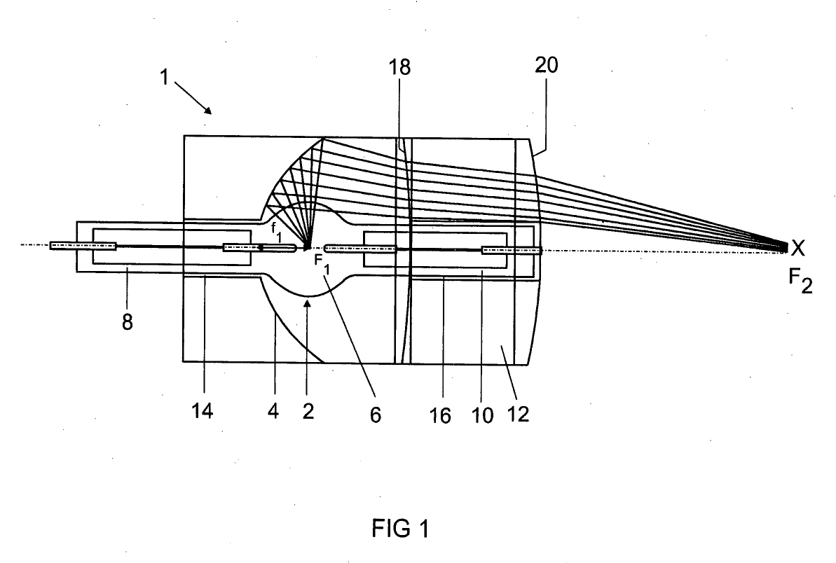

In accordance with FIG. 1, the inventive lamp module 1 has a schematically illustrated lamp 2 that is inserted into a reflector 4 and has a discharge vessel 6 with two lamp shafts 8, 10 arranged diametrically relative to one another, a light directing optical lens 12 being provided for deflecting the radiation, emitted by the lamp 2, from the exit-side lamp shaft 10. By means of the lens 12, the radiation emitted by the lamp 2 is deflected from the exit side lamp shaft 10 so as to prevent shading by the lamp shaft 10 and to ensure the maximum efficiency of the lamp module 1. The rear lamp shaft 8 of the lamp 2 is inserted into a holder 14 of the reflector 4. The lens 12 is fastened on the reflector 4 and forms a front panel of the lamp module 1 such that latter is sealed by the lens 12, at least in some sections. In order to hold the exit side lamp shaft 10, the lens 12 has a cylindrical recess 16 that is arranged approximately in the middle and is penetrated by the lamp shaft 10, at least in some sections. The lens 12 has on the reflector side a concave light entry surface 18, and on the exit side a convex light exit surface 20. The light entry and light exit surfaces 18, 20 of the lens 12

are of conical design, the light exit surface 20 being arranged downstream of the end of the exit side lamp shaft 10. In an exemplary embodiment of the invention that is not illustrated, the light entry and light exit surfaces of the lens are of spherical or aspheric design. For example, the lamp 2 forms with the reflector 4 a preassembled unit that can be inserted into a projector that is not illustrated, for example in a digital projector for data or video projection using DLP/DMD or LCD technology.

In the exemplary embodiment of the invention illustrated, the lamp 2 is designed as a high pressure lamp. The construction of such discharge lamps 2 is known; said lamps are described, for example, at www.osram.de under the name of P-VIP lamps, and so further explanations are superfluous. The discharge vessel 6 of the lamp 2 is arranged inside the reflector 4 in such a way that the discharge arc produced lies at a focal point F₁ of the reflector 4. The focal length f₁ of the focal point F₁ lies in the range of approximately 6 to 8 mm—it has been shown that this measure constitutes an optimum compromise between a compact design and a minimum thermal loading of the lamp 2 and of the reflector 4. The light generated in the discharge vessel 6 by the discharge arc is projected by the reflector 4 and the lens 12 onto the focus F₂, which lies in an input aperture of an integrator (not illustrated). Since the discharge arc does not constitute a point light source, this projection is not performed in punctiform fashion exactly at the focus F₂—as illustrated in an idealized fashion in FIG. 1. Since the light exit surface 20 of the lens 12 offers a further degree of freedom for adapting the emitted light bundle to the desired angular distribution, the numerical eccentricity of the reflector 4 can be selected to be greater so as to enable a longer focal length F₂, and thus the use of lamps 2 of high power with correspondingly longer shaft lengths and greater shaft diameters in conjunction with the same focal point F₁. In the case of the exemplary embodiment illustrated, the reflector 4 is designed as an ellipsoid in some sections, and has a numerical eccentricity in the range of approximately 0.80 to 0.85.

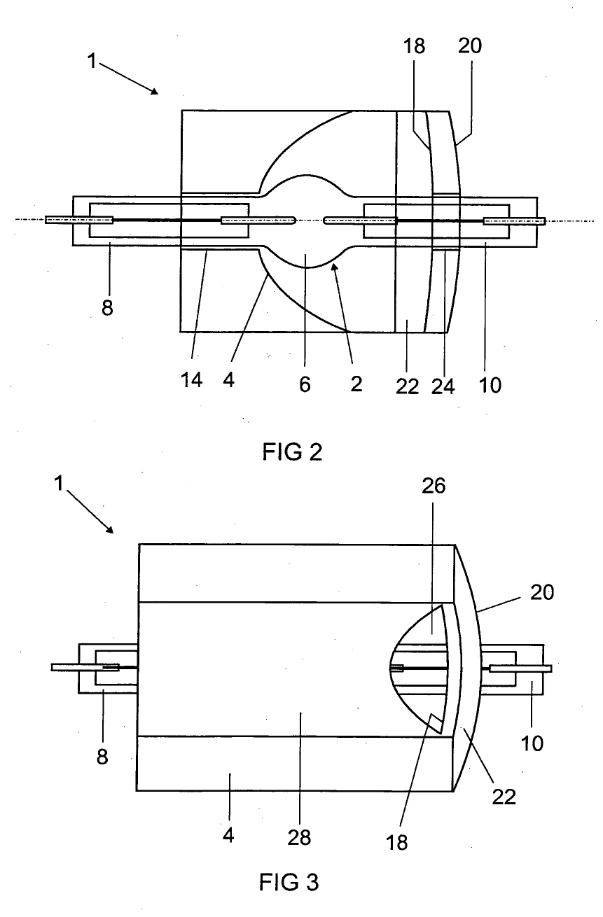

In accordance with FIG. 2, which shows a side view of a lamp module 1 in accordance with a second inventive exemplary embodiment, in this variant the lens 22 has a thickness reduced by comparison with the lens 12 from FIG. 1, and is arranged between the end of the lamp shaft 10 and the discharge vessel 6. In order to hold the exit side lamp shaft 10, the lens 22 has a cylindrical recess 24 that is arranged approximately in the middle and is penetrated by the lamp shaft 10. The lens 22 is designed as a positive lens having a concave light entry surface 18 and a convex light exit surface 20.

As is to be gathered, in particular, from FIG. 3, which shows a plan view of the lamp module 1 from FIG. 2, the lens 22 is fastened on the reflector 4 in such a way that said lens forms a front panel of the lamp module 1, and said module is sealed by the lens 22, in some sections. Because of the heat generation of the lamp 2 and the restriction of service life associated therewith, an effective cooling is advantageous. To this end, air is blown axially into the reflector 4 via a fan (not illustrated). The cooling air flow surrounds the lamp 2 and subsequently

exits the reflector 4 radially via two cooling air outlets 26. Heat is thereby effectively prevented from accumulating in the lamp module 1.

Moreover, reflector 4 and lens 22 are provided with flats 28 arranged spaced apart in parallel and diametrically relative to one another (the other flat is not visible in FIG. 3). It is thereby possible for the installation height of the lamp module 1 to be further minimized.

The inventive lamp module 1 is not restricted to the exemplary embodiment illustrated—rather, the lens 12, 22 can have different shapes known from the prior art. For example, the lens 12, 22 can be of plano-convex design.

What is disclosed is a lamp module 1, in particular for projectors for data or video projection, which has at least one lamp 2 that is inserted into a reflector 4 and has a discharge vessel 6 with two lamp shafts 8, 10 arranged diametrically relative to one another. Provided in accordance with the invention is a light directing optical lens 12, 22 for deflecting the radiation, emitted by the lamp 2, from the exit-side lamp shaft 10.

1. A lamp module, in particular for projectors for data or video projection, having at least one lamp (2) that is inserted into a reflector (4) and has a lamp vessel (6) with two lamp shafts (8, 10) arranged diametrically relative to one another, characterized by a light directing optical lens (12, 22) for deflecting the radiation, emitted by the lamp (2), from the exit-side lamp shaft (10).

2. The lamp module as claimed in claim 1, in which the lens (12, 22) has a recess (16, 24) that is penetrated at least in some sections by the exit-side lamp shaft (10) of the lamp (2).

3. The lamp module as claimed in claim 1 or 2, in which the lens (12, 22) is a positive lens.

4. The lamp module as claimed in claim 1, in which the lens (12, 22) has on the reflector side a concave light entry surface (18), and on the exit side a convex light exit surface (20).

5. The lamp module as claimed in claim 4, in which the light entry and/or light exit surface (18, 20) is of conical, spherical or aspheric design.

6. The lamp module as claimed in claim 4 or 5, in which the lens (12) is designed in such a way that the light exit surface (20) is arranged downstream of the end of the exit side lamp shaft (10).

7. The lamp module as claimed in claim 1, in which the reflector (4) is an ellipsoid, at least in some sections.

8. The lamp module as claimed in claim 1, in which the reflector (4) and/or the lens (12, 22) are provided with at least two flats (28, 30) that are arranged substantially in pairs diametrically relative to one another.

9. The lamp module as claimed in claim 1, in which the reflector (4) has a holding section (14) in which the rear lamp shaft (10) of the lamp (2) can be held.

10. The lamp module as claimed in claim 1, in which the lens (12, 22) is fixed on the reflector (4).

11. The lamp module as claimed in claim 1, in which the focal length (f₁) of the reflector (4) lies in the range of approximately 6 to 8 mm.

12. The lamp module as claimed in claim 1, in which the reflector (4) has a numerical eccentricity (e) in the range of approximately 0.80 to 0.85.

13. The lamp module as claimed in claim 1, in which the lamp shafts (8, 10) of the lamp (2) have a front diameter in the range of approximately 4 to 7.5 mm.

14. The lamp module as claimed in claim 1, in which the lamp (2) is adjusted in the preassembled module composed of reflector (4) and lens (12, 22).

15. The lamp module as claimed in claim 1, in which the lamp (2) is a high-pressure discharge lamp.

16. The lamp module as claimed in claim 1 for use for digital data and video projectors.

17. The lamp module as claimed in claim 1 one of the preceding claims, in which the lamp (2) is a mercury high-pressure discharge lamp.
